(19) United States
(12) Patent Application Publication
(10) Pub. No.: US 2025/0229397 A1
(43) Pub. Date: Jul. 17, 2025

(54) SYSTEMS AND METHODS FOR MODIFYING A PERFORMANCE OF A FASTENER DRIVER

(71) Applicant: MILWAUKEE ELECTRIC TOOL CORPORATION, Brookfield, WI (US)

(72) Inventors: Benjamin OWEN, Indianapolis, IN (US); Brian C. LACINA, Milwaukee, WI (US); Mitchell A. ELLENA, West Allis, WI (US)

(21) Appl. No.: 19/013,715

(22) Filed: Jan. 8, 2025

Related U.S. Application Data
(60) Provisional application No. 63/620,755, filed on Jan. 12, 2024.

(51) Int. Cl. B25C 1/06

(52) U.S. Cl. CPC B25C 1/06

(57) ABSTRACT

A device may include a housing, a drive mechanism disposed within the housing, and a brushless motor within the housing. The brushless motor includes a rotor and a stator and is configured to produce a rotational output to the drive mechanism. The device may further include a battery pack interface configured to couple to a battery pack and an electronic controller electrically coupled to the drive mechanism and the battery pack interface, and configured to determine an operating mode of the fastener driver, monitor a parameter of the battery pack coupled to the battery pack interface, in response to determining that the operating mode is a first operating mode, determine whether the monitored parameter exceeds a predetermined threshold, and adjust a power consumption of the motor in response to determining that the operating mode is the first operating mode and the monitored parameter exceeds the predetermined threshold.

### CROSS-REFERENCE TO RELATED APPLICATION

This applications claims priority to, and the benefit of, U.S. Provisional Patent Application No. 63/620,755, filed Jan. 12, 2024, the contents of which are incorporated herein.

### FIELD

The present application relates to a powered fastener driver such as a nail gun.

### BACKGROUND

Fastener drivers, such as nail guns, are implemented in various use cases. In some, speed may be the driving factor, requiring a bumpfire-type mode to allow for fasteners to be driven as fast as the user requires. However, in other examples, a user may want to extend the operational time of a battery-operated fastener driver. For example, where the user is in an environment where it is not convenient or efficient to exchange the battery pack, the user may wish to extend the life of the fastener driver with the current battery pack as much as possible. The concepts described herein, allow a user the flexibility to modify the operation of the fastener driver based on their needs.

### SUMMARY

Cordless battery powered fasteners are often configured to drive a fastener at a consistent speed while maintaining a consistent power consumption. However, some situations may require the use of increased or decreased operation speeds or power consumption requirements. For example, where the power source has a reduced capacity or performance, it may be advantageous to modify the performance of the fastener device to extend the operational life of the device.

In some aspects, the concepts described herein relate to a fastener driver including a housing, a drive mechanism disposed within the housing, and a brushless motor within the housing. The brushless motor includes a rotor and a stator and is configured to produce a rotational output to the drive mechanism. The fastener driver further includes a battery pack interface disposed on the housing, where the battery pack interface is configured to couple to a battery pack. The fastener driver also includes an electronic controller electrically coupled to the drive mechanism and the battery pack interface. The controller is configured to determine an operating mode of the fastener driver, monitor a parameter of the battery pack coupled to the battery pack interface, and in response to determining that the operating mode is a first operating mode, determine whether the monitored parameter exceeds a predetermined threshold. The controller is also configured to adjust a power consumption of the motor in response to determining that the operating mode is the first operating mode and the monitored parameter exceeds the predetermined threshold.

In some aspects, the concepts described herein relate to a process for controlling a fastener driver, the fastener driver including a battery pack interface configured to couple to a battery pack and a motor. The process includes determining an operating mode of the fastener driver, determining a battery pack parameter of the battery pack, and determining whether the determined parameters exceed a predetermined threshold in response to determining that the operating mode is a first operating mode. The process also includes reducing a power supplied to the motor in response to determining that the operating mode is the first operating mode and the monitored parameter exceeds the predetermined threshold.

In some aspects, the concepts described herein describe a fastener driver including a housing, a drive mechanism disposed within the housing, and a brushless motor within the housing. The brushless motor includes a rotor and a stator and is configured to produce a rotational output to the drive mechanism. The fastener driver further includes a battery pack interface disposed on the housing and configured to couple to a battery pack. The fastener driver also includes an electronic controller electrically coupled to the drive mechanism and the battery pack interface. The electronic controller is configured to receive an instruction to operate in a reduced power mode, reduce a power supplied to the motor by a first amount, monitor a parameter of the battery pack coupled to the battery pack interface, and reduce the power supplied to the motor by at least a second amount in response to the monitored parameter by a value down to a predetermined minimum.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

### BRIEF DESCRIPTION OF THE DRAWINGS

FIG. 1 is a side view of a powered fastener driver, according to some embodiments.

FIG. 2 is a side cross-sectional view of the powered fastener driver of FIG. 1, illustrating a frame assembly and a motor, according to some embodiments.

FIG. 3 is a perspective view of the drive blade and the drive wheel of the powered fastener driver of FIG. 1, according to some embodiments.

FIG. 4 a block diagram of a control system for the powered fastener driver of FIG. 1, according to some embodiments.

FIG. 5 is a flow chart illustrating a process for determining an operating mode of the fastener driver of FIG. 1, according to some embodiments.

FIG. 6 is a flow chart illustrating a process for operating the powered fastener driver of FIG. 1 in a reduced power mode, according to some embodiments.

FIG. 7 is a graph showing commutation of a brushless motor according to some embodiments.

### DETAILED DESCRIPTION

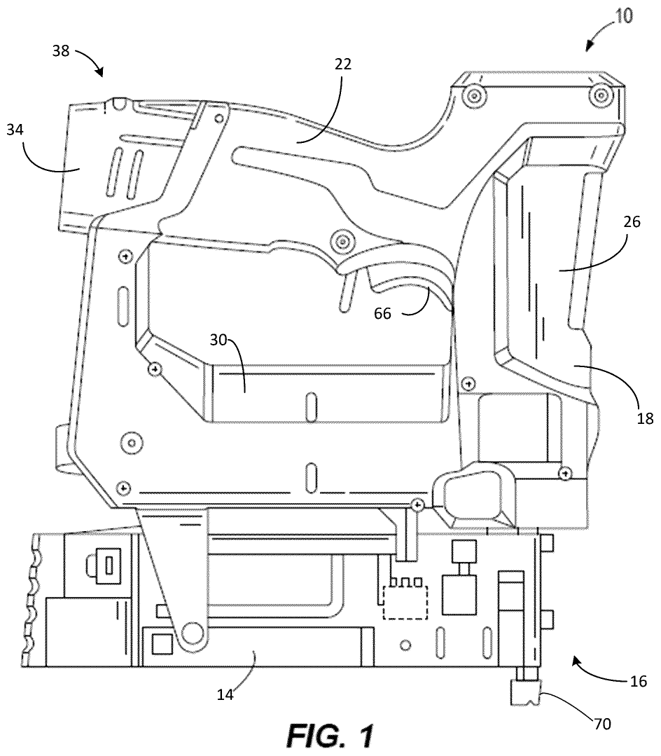

A powered fastener driver 10 is operable to drive fasteners (e.g., nails, tacks, staples, etc.) held within a magazine 14 into a workpiece via an output nose portion 16 of the fastener driver 10. As illustrated in FIG. 1, the fastener driver 10 includes a housing 18 having a handle portion 22, a cylinder support portion 26, and a motor support portion 30. In the illustrated embodiment, the handle portion 22 is integrally formed with the cylinder support portion 26 and the motor support potion 30 as a single piece (e.g., using a casting or molding process, depending on the material used). A power source 34 (e.g., a battery pack) is coupled to a battery attachment interface 38 near the end of the handle portion 22.

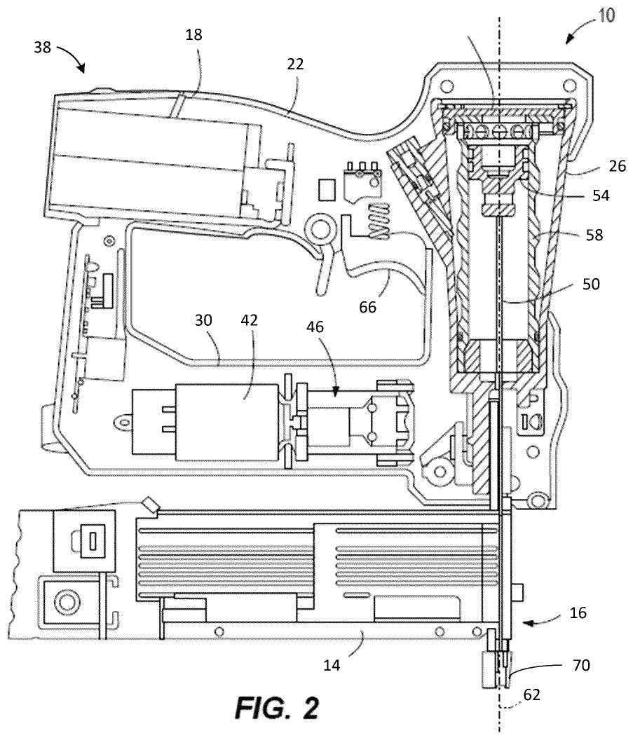

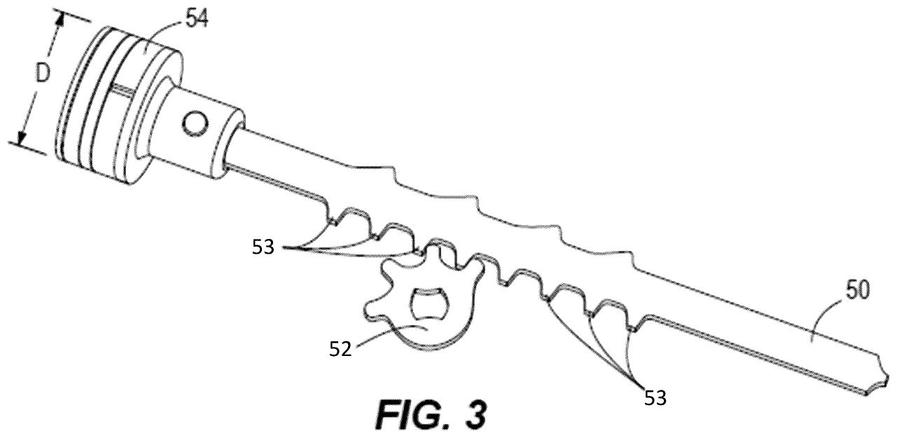

With reference to FIGS. 2 and 3, during operation, a motor 42 disposed in the motor support portion 30 receives power from the power source 34 to rotate a transmission 46. The motor 42 of the fastener driver 10 may be a brushless motor that includes a rotor and a stator and produces a rotational output. The transmission 46 is configured to raise a driver blade 50 between a bottom-dead-center (“BDC”) position toward a top-dead-center (“TDC”) position. In the illustrated embodiment of FIG. 3, the driver blade 50 is raised by a drive gear 52 coupled to the transmission 46. The drive gear 52 is configured to interface with a plurality of teeth 53 disposed on driver blade 50 as the blade 50 is raised to the TDC position. The driver blade 50 is coupled to a movable piston 54. Returning to FIG. 2, the piston 54 is configured to pressurize air within an inner cylinder 58 as the driver blade 50 is moved from the BDC position toward the TDC position. The movement of the driver blade 50 and piston 54 within the inner cylinder 58 define a driving axis 62. As previously mentioned, the driver blade 50 and piston 54 are moveable between a TDC (i.e., retracted) position and a driven or BDC (i.e., extended) position. Upon being driven to the TDC position, the driver blade 50 and piston 54 are disengaged from the motor 42 output, causing the pressure of the inner cylinder 58 to drive the drive blade 50 and piston 54 towards the BDC position and thereby drive a fastener. The drive blade 50 may then reengage with the motor 42 output and be driven back from the BDC position to the TDC position. Accordingly, during operation, the drive blade 50 reciprocates between the BDC position and the TDC position. The illustrated fastener driver 10 operates on a gas spring principle utilizing the piston 22 to compress the gas within the inner cylinder 58. In other embodiments, the fastener driver 10 may use another means of storing and releasing energy (e.g., a spring). The fastener driver 10 may include multiple inputs and sensors such as a trigger 66 operable by the user and a bump sensor 62.

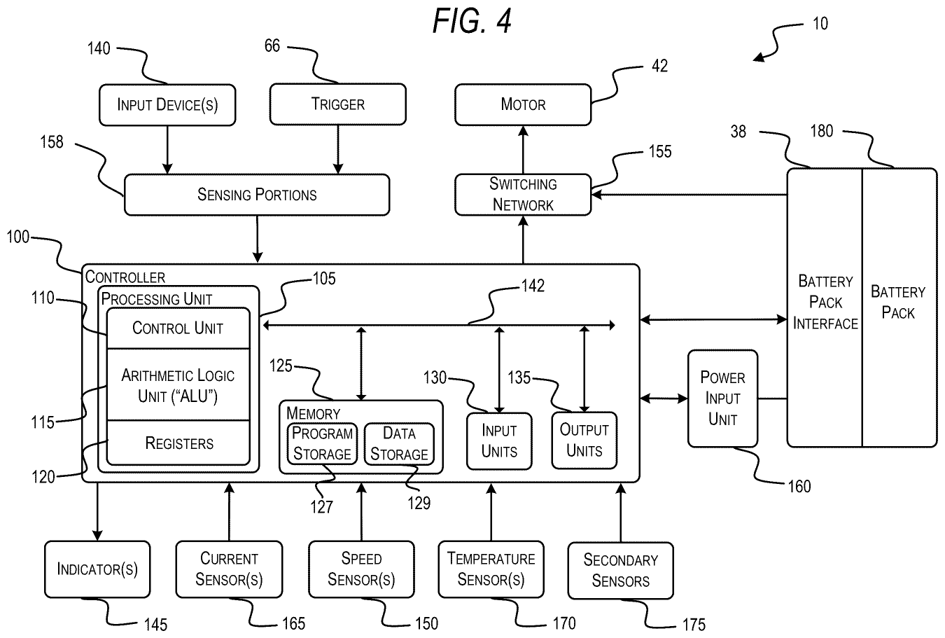

FIG. 4 illustrates a controller 100 for the fastener driver 10. The controller 100 is electrically and/or communicatively connected to a variety of modules or components of the fastener driver 10 and includes a plurality of electrical and electronic components that provide power, operational control, and protection to the components and modules within the controller 100 and/or fastener driver 10. For example, the controller 100 includes, among other things, a processing unit 105 (e.g., a microprocessor, an electronic processor, an electronic controller, a microcontroller, or another suitable programmable device), a memory 125, input units 130, and output units 135. The processing unit 105 includes, among other things, a control unit 110, an arithmetic logic unit (“ALU”) 115, and a plurality of registers 120 (shown as a group of registers in FIG. 4) and is implemented using a known computer architecture (e.g., a modified Harvard architecture, a von Neumann architecture, etc.). The processing unit 105, the memory 125, the input units 130, and the output units 135, as well as the various modules connected to the controller 100 are connected by one or more control and/or data buses (e.g., common bus 142). The control and/or data buses are shown generally in FIG. 4 for illustrative purposes. The use of one or more control and/or data buses for the interconnection between and communication among the various modules and components would be known to a person skilled in the art in view of the embodiments described herein.

The memory 125 is a non-transitory computer readable medium and includes, for example, a program storage area 127 and a data storage area 129. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 105 is connected to the memory 125 and executes software instructions that are capable of being stored in a RAM of the memory 125 (e.g., during execution), a ROM of the memory 125 (e.g., on a generally permanent basis), or another non-transitory computer readable medium such as another memory or a disc. Software included in the implementation of the fastener driver 10 can be stored in the memory 125 of the controller 100. The software includes, for example, firmware, one or more applications, program data, filters, rules, one or more program modules, and other executable instructions. The controller 100 is configured to retrieve from the memory 125 and execute, among other things, instructions related to the control processes and methods described herein. In other embodiments, the controller 100 includes additional, fewer, or different components.

The controller 100 drives the motor 42 to rotate a driver in response to a user's actuation of the trigger 66. The controller 100 may also utilize inputs from other input devices 140 such as the bump switch 70 to determine when to drive the motor 42 or a mode selector to allow the user to control the operation mode of the driver 10. Depression of the trigger 66 actuates a trigger switch, which outputs a signal to the controller 100 to drive the motor 42, and therefore the driver 10. Depression of the pump switch 70 may also output a signal to the controller 100 to drive the motor 42. In some embodiments, the trigger 66 or other input devices 140 may include other sensors (e.g., a pressure sensor) with sensing portions 158 configured to communicate with the controller 100. Based on the signal from the trigger and/or the input devices 140, the controller 100 controls the power switching network 155 (e.g., a FET switching bridge) to drive the motor 42. For example, the power switching network 155 may include a plurality of high side switching elements (e.g., FETs) and a plurality of low side switching elements. The controller 100 may control each FET of the plurality of high side switching elements and the plurality of low side switching elements to drive each phase of the motor 42. For example, the power switching network 155 may be controlled to more quickly deaccelerate the motor 42. In some embodiments, the controller 100 monitors a rotation of the motor 42 (e.g., a rotational rate of the motor 42, a velocity of the motor 42, a position of the motor 42, and the like) via the speed sensor 150.

The controller may also be connected to additional sensors and components including an indicator 145, a power input unit 160, a current sensor 165, a temperature sensor 170, and other secondary sensors 175. In other embodiments, the controller 100 includes additional, fewer, or different sensor components. The current sensor 165 may be configured to sense various currents within the fastener driver 10, such as a current output of a battery pack 180, a current draw associated with the motor 42, and/or other currents within the fastener driver 10. In some embodiments, the current sensor 165 senses at least one of the phase currents of the motor 42. The current sensor 165 may be, for example, an inline phase current sensor, a pulse-width-modulation-center-sampled inverter bus current sensor, or the like. The speed sensor 150 is configured to sense a speed of the motor 42. The speed sensor 150 may include, for example, one or more Hall effect sensors. In some embodiments, the temperature sensor 170 senses a temperature of various components and/or portions of the fastening device, such as the power switching network 155, the battery pack 180, the motor 42, and/or other components described herein.

The indicators 145 (e.g., a mode indicator, a battery pack state-of-charge indicator, etc.) are also connected to the controller 100 and receive control signals from the controller 100 to turn on and/or off or otherwise convey information to a user based on different states/parameters of the fastener driver 10. The indicators 145 may include, for example, one or more light-emitting diodes (LEDs), a display screen, and/or a combination thereof. The indicators 145 may be configured to display conditions of, or information associated with, the fastener driver 10. For example, the indicators 145 may display information relating to an operational state of the fastener driver 10, such as a mode (e.g., a sequential mode, a bump fire mode, and/or other modes as required for a given application) or speed setting. The indicators 145 may also display information relating to a fault condition, or other parameters of the fastener driver 10. In addition to or in place of visual indicators, the indicators 145 may also include a speaker or a tactile feedback mechanism to convey information to a user through audible or tactile outputs. In some embodiments, the indicators 145 display information related to a braking operation or a clutch operation (e.g., an electronic clutch operation) of the controller 100. For example, one or more LEDs may be activated in response to the controller 100 performing a clutch operation.

The battery pack interface 38 is connected to the controller 100 and is configured to interface with a battery pack 180. The battery pack interface 38 includes a combination of mechanical (e.g., a battery pack receiving portion) and electrical components configured to and operable for interfacing (e.g., mechanically, electrically, and communicatively connecting) the fastener driver 10 with the battery pack 180. The battery pack 180 may be a lithium-ion battery pack such as Milwaukee Tool's M12 and/or M18 battery pack. The battery pack 180 may also be other models of battery or utilize different chemistries as required for a given application. The battery pack interface 38 is coupled to the power input unit 160. The battery pack interface 38 transmits the power received from the battery pack 180 to the power input unit 160. The power input unit 160 includes active and/or passive components (e.g., voltage step-down controllers, voltage converters, rectifiers, filters, etc.) to regulate and/or control the power received through the battery pack interface 38 and to the controller 100. In some embodiments, the battery pack interface 38 is also coupled to the power switching network 155. The operation of the power switching network 155, as controlled by the controller 100, determines how power is supplied to the motor 42. Accordingly, in some embodiments, the controller 100 may communicate with the power input unit 160 to control the power supplied to the fastener driver 10.

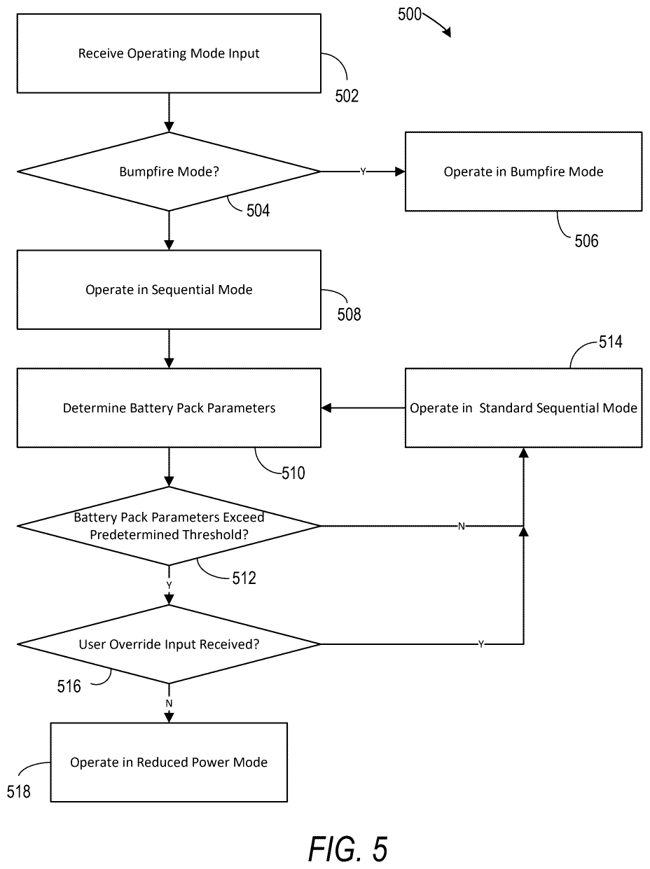

FIG. 5 illustrates a process 500 for determining an operational mode of a power tool, such as driver 10. In some embodiments, the operational mode may be a driver 10 specific function, such as a sequential operating mode and/or a bumpfire operating mode. In a sequential operating mode, the driver 10 performs a single operation (e.g., driving a fastener for every press of the trigger 66. In a bumpfire mode, the driver 10 drives a fastener each time the bump switch 70 is depressed as long as the trigger 66 is also depressed, allowing for faster operation. At process block 502 the controller 100 receive an operational mode input. In one embodiment, the operational mode input may be received via the one or more input device 140. Operational mode inputs may include a sequential operational mode input and/or a bumpfire operational mode input. However, other operational modes are contemplated, as required for a given application.

At process block 504, the controller 100 determines whether the received operational mode input is a bumpfire operational mode input. In response to determining that the received operational mode input is a bumpfire operational mode input, the controller controls the driver 10 to operate in bumpfire operational mode at process block 506.

In response to determining that the received operational mode input is not the bumpfire operational mode input, the controller 100 controls the driver to operate in the sequential operating mode at process block 508. In response to operating in the sequential operating mode, the controller 100 determines one or more parameters associated with the battery pack 180 at process block 510. Battery pack parameters may include battery state-of-charge (SoC), battery state-of-health (SoH), battery impedance (e.g., age), battery identity (e.g., battery power characteristics, 2 Ah, 4 Ah, etc.). However, other battery pack parameters may be determined as required for a given application. In some embodiments, the controller 100 may communicate directly with a secondary controller (not shown) of the battery pack, which can provide one or more battery pack parameters. In other embodiments, the sensors, such as current sensors 165, temperature sensors 170, and/or secondary sensor 175 may be used to determine the battery pack parameters. In still further embodiments, the battery pack parameters may be determined by the controller 100 based on a combination of sensed data from the sensors (e.g., current sensors 165, temperature sensors 170, and/or other secondary sensors 175) in combination with data received from the secondary controller of the battery pack 180.

In response to determining the one or more battery pack parameters, the controller 100 determines whether the battery pack parameters exceed a predetermined threshold value. For brevity, it is understood that “exceeds” includes the value being above or below a predetermined threshold as required for a given application. The predetermined threshold value may be associated with one or more of the battery parameters. For example, one predetermined threshold may be 80% of nominal SoC. However, values or more than 80% or less than 80% are also contemplated as required for a given application. In other examples, the predetermined threshold may be associated with one or more other parameters of the battery pack, such as a battery impedance. For example, the predetermined threshold may be a certain percentage over a nominal impedance, which could indicate an age or state of the battery pack.

In response to the controller 100 determining that the determined battery pack parameters do not exceed a predetermined threshold value, the controller 100 control the driver 10 to operate in a standard sequential operating mode at process block 514. When operating in the standard sequential operating mode, the driver 10 operates to maximize power to the motor 42 to ensure consistent operation.

In response to the controller 100 determining that the determined battery pack parameters do exceed the predetermined threshold value, the controller 100 determines whether a user override input has been received at process block 516. In one embodiment, the user override input may be provided by a user via the input devices 140. In one example, the user override prevents the driver 10 from being switched into a reduced power (“marathon”) mode, as described in more detail below. In response to determining that the user override input has been received, the controller 100 operates the tool in the standard sequential operating mode at process block 514.

In response to the controller 100 determining that no user override input has been received, the controller 100 operates the driver 10 in a reduced power mode. As will be described in more detail below, the reduced power mode is configured to reduce power consumption using one or more modifications to the operation of the driver 10 to increase the operational life (i.e., the amount of time that a coupled battery pack can provide power to operate the driver 10) of the battery pack 180.

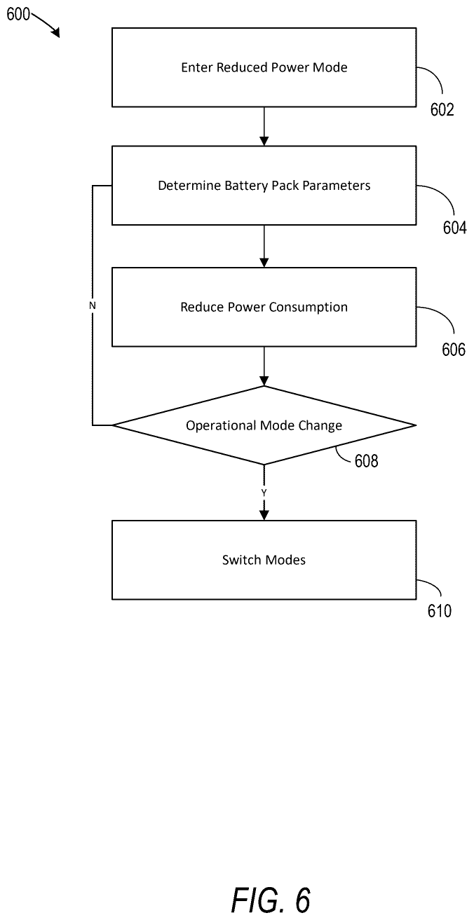

Turning now to FIG. 6, a process 600 for operating the driver 10 in a reduced power mode is shown. At process block 602, the controller 100 controls the driver to operate in the reduced power mode, as noted above. In some embodiments, the controller 100 may receive an instruction from a user, such as via input devices 140, requesting to operate in the reduced power mode. At process block 604, the controller 100 monitors one or more battery pack parameters. As noted above, the battery pack parameters may include battery charge (SoC), battery health (SoH), battery impedance (e.g., age), battery identity (e.g., battery power characteristics, 2 Ah, 4 Ah, etc.) and/or other battery pack parameters as required for a given application.

At process block 606, the controller 100 reduces a power consumption of the driver 10. In one embodiment, the power consumption is reduced by modifying one or more parameters of the motor 42. However, it is contemplated that power consumption may be reduced by controlling power to one or more other components of the driver 10, as required for a given application. In some examples, the power consumption of the motor 42 is reduced by a first amount. An example first amount may be set based on one or more battery parameters, the received instruction, or be a pre-set amount. For example, a preset amount may be 10%; however, values of more than 10% or less than 10% may also be used as required for a given application.

In one example, the controller 100 may reduce the power consumption by reducing a speed of the motor 42. For example, where the controller 100 uses a proportional-integral-derivative (“PID”) control scheme to control the motor 42, the weights (Kp/Ki/Kd) and error percentages used to regulate the speed of the motor may be correspondingly adjusted based on the monitored battery pack parameters. For example, the controller 100 may be configured to increase the speed control weights for the Kp and/or Ki elements of the PID control scheme to decrease the speed of the motor 42, thereby reducing a power consumption of the motor 42. In other examples, the controller 100 may also be configured to adjust an error of the PID control scheme in order to account for potential undershooting resulting from decreasing the speed control weights. In some examples, the speed control signal may be generated using only the error value. Additionally, where the controller 100 uses PWM to control the motor, the duty cycles of each phase may be correspondingly adjusted to further reduce the speed of the motor. While the above example described using a PID control scheme, it is contemplated that other control schemes, such as PD or PI schemes may be used, as required for a given application.

In another example, the controller 100 may reduce the power consumption of the driver 10 by adjusting a delay between each portion of the drive cycle (e.g., engage drive gear 52 with drive blade 50, move drive blade 50 to the TDC position, release drive blade 50, etc.) of the driver 10 in order to decrease the speed and/or increase the efficiency of the drive cycle. For example, the controller 100 may increase the delay between when the drive blade 50 is released and when the drive gear is engaged by the drive gear 52 in order to utilize a lifter “bounceback,” or when the drive blade 50 moves up from the BDC toward the TDC due to the impact on the driver and the negative pressure of the spring.

In other examples, the controller 100 may reduce the power consumption of the driver 10 by adjusting and/or limiting a current provided to the motor 42 based on the monitored battery pack parameters. For example, the controller 100 may adjust a hardware overcurrent threshold of the driver 10. The hardware overcurrent threshold is a current threshold representing a maximum allowable current in the driver 10. The controller 100 may be configured to control a power switch to shut off power to the motor 42 in response to a sensor detecting a larger current than the hardware overcurrent threshold. Accordingly, in some embodiments, the controller 100 may control an overcurrent switch to control the amount of current provided to the motor 42, such as by reducing the hardware overcurrent threshold to reduce the maximum current used by the motor 42. In some embodiments, other hardware thresholds (e.g., slew rate) may also be adjusted.

In other examples, the controller 100 may reduce the power consumption of the driver 10 by adjusting the commutation of the motor 42 based on the monitored battery pack parameters. Adjusting commutation of the motor 42 is described in further detail in graph 700. The controller 100 may be configured to adjust the conduction angle applied to each phase of the motor 42. Additionally, the controller 100 may adjust the phase advance applied to each phase of the motor 42. In some embodiments, the controller 100 may apply conduction angle control, phase angle control, or a combination of field weakening methodologies to control the motor 42 of the driver 10. In some examples, the controller 100 may be configured to vary the application of at least one field weakening methodology based on a monitored battery pack parameters (e.g., battery voltage, battery temperature, etc.). In some embodiments, the controller 100 may vary a combination of at least one field weakening methodology and the apparent power applied to the motor 42 of the driver 10.

In some examples, the controller 100 may include a signal conditioning module (not shown) configured to convert a motor control signal into a splined curve. For example, the signal conditioning module may adjust a linear signal such that the splined output increases rapidly before reducing the rate of change to achieve the same maximum output as the linear output of the feedback control block while using less power. In some embodiments, the signal conditioning block uses one or more piecewise polynomial functions to generate the splined output. In other embodiments, other functions may be utilized, or the processing may be done by the controller 100. Further, while the signal conditioning module is described above with generating a splined output, other output types, such as logarithmic, parabolic, etc. may be output from the signal conditioning module or controller 100. In some embodiments, the spline parameters may be adjusted according to the operating mode. For example, the functions used to generate the splined output may be increased for the performance mode 515 or decreased for the marathon mode 505. Said another way, each operation mode may utilize custom spline parameters.

In some embodiments, the process 600 continues to process block 605 after process block 630 and continues to monitor the power from the battery pack 180 upon adjusting the power to the motor 42. Accordingly, the process 500 may continuously adjust the performance thresholds and reduce the power of the motor continuously up to a predetermined minimum. For example, the power consumption of the motor may be reduced in sync with a decrease in available power in the battery pack 180. However, in other examples continued to reduction of the power to the motor 42 may be reduced and/or controlled based on other parameters, as required for a given application. In some embodiments a delay may be added between resets. In other embodiments, the process 600 may only be implemented by the controller 100 once. In yet other embodiments, the process 600 may only be implemented based on a user operation.

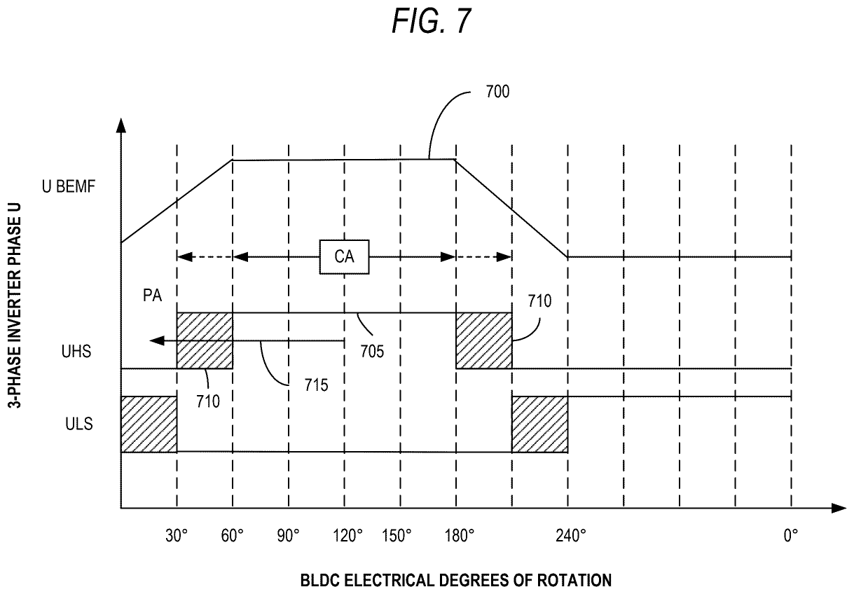

FIG. 7 is a graph 700 illustrating commutation applied to the motor 42 in the fastener driver 10. For example, the conduction angle of the motor 42 may be increased. Increasing the conduction angle, as shown by shaded portions 710, allows for more current to flow through the motor windings for a longer duration, resulting in higher torque production and is beneficial for maintaining motor performance at higher speeds. However, increasing the amount of current flowing through the motor 42 may result in larger resistive losses, and therefore be less efficient. The conduction angle 705 may additionally or alternatively be shifted to occur earlier in the conduction cycle (i.e., phase advance), as shown by phase advance line 715. Generally, a phase advance applied to a brushless DC motor (e.g., the motor 42) allows the motor to achieve higher speeds by aligning the current waveform with the motor's back EMF, which may weaken the magnetic field of the motor. As a result, a phase advance applied to the motor 42 may reduce may allow the motor 42 to operate at higher speeds with a reduced torque output. However, applying a phase advance can increase the current drawn by the motor 42 due to increasing the current ripple, thereby increasing the amount of power consumed by the motor. Accordingly, while operating in the performance reduction mode, the controller 100 may utilize field weakening by adjusting the conduction angle and phase advance of the motor 42 in order to increase the performance of the motor at a reduced efficiency. Said another way, the performance mode may use field weakening to increase the operation speed of the driver 10.

What is claimed is:

1. A fastener driver comprising:
a housing;
a drive mechanism disposed within the housing;
a brushless motor within the housing, the brushless motor including a rotor and a stator and configured to produce a rotational output to the drive mechanism;
a battery pack interface disposed on the housing, the battery pack interface configured to couple to a battery pack; and
an electronic controller electrically coupled to the drive mechanism and the battery pack interface, the controller configured to:
determine an operating mode of the fastener driver;
monitor a parameter of the battery pack coupled to the battery pack interface,
in response to determining that the operating mode is a first operating mode, determine whether the monitored parameter exceeds a predetermined threshold; and
adjust a power consumption of the motor in response to determining that the operating mode is the first operating mode and the monitored parameter exceeds the predetermined threshold.

2. The fastener driver of claim 1, wherein the monitored parameter includes one or more selected from a group consisting of: a battery voltage, a battery temperature, a battery capacity, battery health, and a battery identity.

3. The fastener driver of claim 1, wherein the first operating mode is a sequential operating mode.

4. The fastener driver of claim 1, wherein the controller reduces the power supplied to the motor by limiting a current supplied to the motor by the battery pack.

5. The fastener driver of claim 4, wherein the controller limits the current supplied to the motor by the battery pack by adjusting a hardware overcurrent threshold.

6. The fastener driver of claim 1, wherein the controller reduces the power supplied to the motor by adjusting a duty cycle parameter.

7. The fastener driver of claim 1, wherein the controller is further configured to, in response to determining that the operating mode is a second operating mode, disable the adjustment of the power consumption of the motor.

8. The fastener driver of claim 7, wherein the second operating mode is a bumpfire mode.

9. The fastener driver of claim 1, wherein the controller adjusts power consumption of the motor using field weakening.

10. A method of controlling a fastener driver, the fastener driver including a battery pack interface configured to couple to a battery pack and a motor, the method comprising:
determining an operating mode of the fastener driver;
determining a battery pack parameter of the battery pack;
determining whether the determined parameter exceed a predetermined threshold in response to determining that the operating mode is a first operating mode; and
reducing a power supplied to the motor in response to determining that the operating mode is the first operating mode and the determined parameter exceeds the predetermined threshold.

11. The method of claim 10, wherein the determined parameter includes one or more selected from a group consisting of: a battery voltage, a battery temperature, a battery capacity, battery health, and a battery identity.

12. The method of claim 10, wherein the first operating mode is a sequential operating mode.

13. The method of claim 12, further comprising reducing the power supplied to the motor by limiting a current supplied to the motor by the battery pack.

14. The method of claim 10, further comprising reducing the power supplied to the motor by applying field weakening to the motor.

15. A fastener driver comprising:
a housing;
a drive mechanism disposed within the housing;
a brushless motor within the housing, the brushless motor including a rotor and a stator and configured to produce a rotational output to the drive mechanism;
a battery pack interface disposed on the housing, the battery pack interface configured to couple to a battery pack; and
an electronic controller electrically coupled to the drive mechanism and the battery pack interface, the electronic controller configured to:
receive an instruction to operate in a reduced power mode;
reduce a power supplied to the motor by a first amount;
monitor a parameter of the battery pack coupled to the battery pack interface; and
reduce the power supplied to the motor by at least a second amount in response to the monitored parameter by a value down to a predetermined minimum.

16. The fastener driver of claim 15, wherein the monitored parameter includes one or more selected from a group consisting of: a battery voltage, a battery temperature, a battery capacity, battery health, and a battery identity.

17. The fastener driver of claim 15, wherein the power consumption of the motor is reduced by reducing a speed of the motor.

18. The fastener driver of claim 15, wherein the controller reduces the power supplied to the motor by limiting a current supplied to the motor by the battery pack.

19. The fastener driver of claim 18, wherein the controller limits the current supplied to the motor by the battery pack by adjusting a hardware overcurrent threshold.

20. The fastener driver of claim 15, wherein the controller reduces the power supplied to the motor by adjusting a duty cycle parameter.
